(19) United States
(12) Patent Application Publication
(10) Pub. No.: US 2009/0014439 A1
(43) Pub. Date: Jan. 15, 2009

(54) Non-Contact High-Frequency Induction Heating Apparatus for Plastic Mold and Injection Nozzle Thereof

(76) Inventor: Ji-Hee Kim, Guri (KR)

Correspondence Address: Thomas M. Galgano;Galgano & Associates, 20 W. Park Avenue, Suite 204, Long Beach, NY, 11561, US

(21) Appl. No.: 12/224,100

(22) PCT Filed: Mar. 2, 2007
(86) PCT No.: PCT/KR2007/001044

§ 371 Date: Aug. 14, 2008

(30) Foreign Application Priority Data
Mar. 3, 2006 (KR) 10-2006-0020284
Mar. 3, 2006 (KR) 10-2006-0020285
Jun. 2, 2006 (KR) 10-2006-0049663

(51) Int. Cl. H05B 6/14

(52) U.S. Cl. 219/634

(57) ABSTRACT

Disclosed is a non-contact high-frequency induction heating apparatus for plastic mold and injection nozzle thereof in that only a partial area of a cavity and a runner area of an injection nozzle are rapidly heated by means of a non-contact high-frequency induction heating manner during the injection of a melting resin of high temperature, so that it can minimize a temperature variation between the cavity and runner and the melting resin of high temperature in order to smoothly supply the melting resin to the cavity and injection nozzle, whereby preventing various outward inferiorities of the molding product and improving the efficiency of the melting resin injection apparatus. The non-contact high-frequency induction heating apparatus for injection nozzle of a plastic mold comprises an injection nozzle for injecting a melting resin from a melting resin injection apparatus into the plastic mold; a high-frequency induction coil wound along a periphery of the injection nozzle; and a high-frequency power supply portion for supplying a high-frequency power to the high-frequency induction coil so as to rapidly heat a runner of the injection nozzle by means of a magnetic field of the high-frequency induction coil.

### TECHNICAL FIELD

The present invention relates to a non-contact high-frequency induction heating apparatus for plastic mold and injection nozzle thereof, more particularly, to a non-contact high-frequency induction heating apparatus for plastic mold and injection nozzle thereof in that only a partial area of a cavity and a runner area of an injection nozzle are rapidly heated by means of a non-contact high-frequency induction heating manner during the injection of a melting resin of high temperature, so that it can minimize a temperature variation between the cavity and runner and the melting resin of high temperature in order to smoothly supply the melting resin to the cavity and injection nozzle, whereby preventing various outward inferiorities of the molding product and improving the efficiency of the melting resin injection apparatus.

### BACKGROUND ART

Generally, in a molding of a plastic product such as a plastic clip and so on, a melting resin (plastic materials) of high temperature is injected into a cavity of a core through a runner of a plastic injection mold and is cooled through a cooling process to be separated from the core, thereby completing the plastic product.

In the conventional plastic injection mold, since it is necessary to perform the cooling process as described above during the molding of the plastic product, a cooling apparatus having a temperature lower than that of the molding is formed around the mold. Here, the set temperature of the cooling apparatus is always lower than that of the injected resin.

However, where the melting resin of high temperature is injected into the cavity of the core, since the melting resin of high temperature is injected into the cavity of comparatively lower temperature, the melting resin of high temperature is contacted with the surface of the cool cavity to be quickly cooled. Accordingly, various inferiorities of the molding product such as a contraction of the product, a surface inferiority (a spot (weld line) owing to a flowing deterioration), a size instability, and an external form inferiority and so on.

Accordingly, it has been variously made to solve the above-mentioned problems. However, basically, since it is necessary for the mold (cavity and core) to be always maintained in a comparatively low temperature on account of the productivity and hardness of the product. Thus, as soon as the plastic liquid material of high temperature is injected into and contacted with the mold, since the flowing deterioration and contraction thereof are generated at the same time, there is a limit as ever.

In the meantime, the plastic injection mold includes a fixing molding portion and a moving mold portion in order to separate the product from the mold during ejection thereof. In a state that the fixing molding portion and the moving mold portion are coupled to each other, the melting resin materials of high temperature for molding the product is supplied between the fixing molding portion and the moving mold portion through the runner and then, the supplied melting resin is molded in the core to be separated from the mold, thereby completing the plastic material. Here, the structure of the runner severs as a very important path for molding the product through the plastic injection mold.

In a construction of a conventional manifold of supplying the melting resin to an injection nozzle for opening and closing the runner gate, a plurality of injection nozzles having a piston built in a cylinder and a runner is attached to a mold plate and a manifold having a runner for supplying the melting resin is formed at the injection nozzles, so that the melting resin is supplied to the injection nozzles through the manifold.

In the conventional manifold having the above-structure, in order to smoothly supply the melting resin passing through the runner of the manifold for supplying the melting resin to the injection nozzles, a heating apparatus of a direct contact type such as a column type heater or an embedded cartridge heater and so on is formed at a pre-determined area of the manifold and another heater such as a band heater is formed at the injection nozzle.

However, in case of the above direct heating manner, since the heat loss is larger and the heating condition is varied according to the bonding state thereof, the necessary time for heating is comparatively longer and a partial heating is impossible, so that it is unfit for the heating of a partial area of the injection nozzle in which the fluctuation in temperature is repeated during the molding of the product.

### DISCLOSURE OF INVENTION

### Technical Problem

It is, therefore, an object of the present invention provides a non-contact high-frequency induction heating apparatus for plastic mold in that only a partial area of a cavity is rapidly heated by means of a non-contact high-frequency induction heating manner during the injection of a melting resin of high temperature, so that it can minimize a temperature variation between the cavity and the melting resin of high temperature in order that the temperature of the mold is similar to that of the melting resin (partial or entire mold) until just prior to the molding, whereby solving various inferiorities of a molding product such as a contraction of the product, a weld line, a short shot, a spot and so on during filling into the cavity of the mold.

Another object of the present invention provides a non-contact high-frequency induction heating apparatus for injection nozzle in that only a runner gate of an injection nozzle are rapidly heated by means of a non-contact high-frequency induction heating manner during the injection of a melting resin of high temperature, so that it can minimize a temperature variation between the cavity and runner and the melting resin of high temperature in order to smoothly supply the melting resin to the cavity and injection nozzle and fluctuate in temperature of the injection nozzle in short time, whereby improving the efficiency of the melting resin injection apparatus.

Further Another object of the present invention provides a non-contact high-frequency induction heating apparatus for injection nozzle in that, where the melting resin injection apparatus is connected to the injection nozzle via a manifold, the non-contact high-frequency induction heating apparatus is applied to the injection nozzle while a direct heating manner is used in the manifold, whereby satisfying economical efficiency and quality at same time.

### Technical Solution

To accomplish the objects, the present invention provides a non-contact high-frequency induction heating apparatus for plastic mold having a core and a cavity comprising: at least one high-frequency induction coil formed at an outside of the cavity; and a high-frequency power supply portion for supplying a high-frequency power to the high-frequency induction coil so as to rapidly heat only the cavity by means of a magnetic field of the high-frequency induction coil.

Preferably, the high-frequency induction coil is at least one wound coil.

Preferably, the cavity is rapidly heated prior to an injection of a melting resin of high temperature into the cavity.

Preferably, the non-contact high-frequency induction heating apparatus for plastic mold further comprises a controller for controlling the high-frequency power supplied to the high-frequency induction coil through the high-frequency power supply portion and the cooling water supplied to the cooling apparatus.

Preferably, a plurality of cooling apparatuses using a cooling water supplying manner is formed at an outside of the core.

To accomplish the objects, the present invention provides a non-contact high-frequency induction heating apparatus for injection nozzle of a plastic mold comprising: an injection nozzle for injecting a melting resin from a melting resin injection apparatus into the plastic mold; a high-frequency induction coil wound along a periphery of the injection nozzle; and a high-frequency power supply portion for supplying a high-frequency power to the high-frequency induction coil so as to rapidly heat a runner of the injection nozzle by means of a magnetic field of the high-frequency induction coil.

Preferably, the injection nozzle comprises a spiral groove formed at a periphery t hereof and the high-frequency induction coil is wound along the spiral groove.

Preferably, the injection nozzle comprises a spiral protrusion formed at a periphery thereof and the high-frequency induction coil is wound along the spiral protrusion.

Preferably, the spiral groove or spiral protrusion are concentrically formed on at least any one among a front portion, a central portion and a rear portion of the injection nozzle.

Preferably, the spiral groove or spiral protrusion are widely formed on at least any one among a front portion, a central portion and a rear portion of the injection nozzle and the high-frequency induction coil is concentrically wound along the widen spiral groove or spiral protrusion.

Preferably, two spiral grooves are formed at upper and lower portions of the injection nozzle respectively, two metallic C-rings are inserted into and fixed to the spiral grooves respectively, both ends of the high-frequency induction coil are inserted into and fixed to the metallic C-rings and then, the high-frequency induction coil is wound along a space between the spiral grooves of the injection nozzle.

Preferably, a temperature detection sensor line for detecting a temperature of the runner is wound along the spiral groove or spiral protrusion together with the high-frequency induction coil.

Preferably, the high-frequency induction coil wound along the spiral groove or spiral protrusion of the injection nozzle comprises a plurality of loops.

Preferably, the melting resin injection apparatus is connected to the injection nozzle via a manifold.

Preferably, a heating apparatus for heating a runner of the manifold is formed at an outside of the manifold.

Preferably, the runner of the injection nozzle is rapidly heated prior to an injection of a melting resin of high temperature into the runner of injection nozzle.

### ADVANTAGEOUS EFFECTS

As described above, according to the non-contact high-frequency induction heating apparatus for plastic mold, during the injection of a melting resin of high temperature, only a partial area of a cavity is rapidly heated by means of the non-contact high-frequency induction heating manner, so that it can minimize a temperature variation between the cavity and the melting resin of high temperature in order that the temperature of the mold is similar to that of the melting resin (partial or entire mold) until just prior to the molding, thereby solving various inferiorities of a molding product (a contraction of the product, a weld line, a short shot, a spot and so on) during filling into the cavity of the mold.

Also, according to the non-contact high-frequency induction heating apparatus for injection nozzle, only a runner gate of an injection nozzle are rapidly heated by means of a non-contact high-frequency induction heating manner during the injection of a melting resin of high temperature, so that it can minimize a temperature variation between the cavity and runner and the melting resin of high temperature in order to smoothly supply the melting resin to the cavity and injection nozzle and fluctuate in temperature of the injection nozzle in short time, whereby improving the efficiency of the melting resin injection apparatus.

Also, in case that the melting resin injection apparatus is connected to the injection nozzle via a manifold, the non-contact high-frequency induction heating apparatus is applied to the injection nozzle while a direct heating manner is used in the manifold, whereby satisfying economical efficiency and quality at same time.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a planar view illustrating a plastic injection mold using a non-contact high-frequency induction heating apparatus according to the present invention;

FIG. 2 is a schematically planar view illustrating a flow of a melting resin of high temperature in a cavity;

FIG. 3 is a schematically planar view illustrating a partial area of a cavity of heating rapidly by means of a non-contact high-frequency induction heating apparatus for plastic mold according to the present invention;

FIG. 4 is a schematically planar view illustrating the formation of the magnetic field through a non-contact high-frequency induction heating apparatus for plastic mold according to the present invention;

FIG. 5 is a schematic sectional view illustrating an injection nozzle of a non-contact high-frequency induction heating apparatus according to one embodiment of the present invention;

FIG. 6 is a schematic sectional view illustrating an injection nozzle of a non-contact high-frequency induction heating apparatus according to another embodiment of the present invention;

FIG. 7 is a sectional view illustrating a state of winding a high-frequency induction coil on the injection nozzle of FIG. 6;

FIG. 8 is a sectional view illustrating a state of winding a high-frequency induction coil on an injection nozzle according to further another embodiment of the present invention;

FIG. 9 is a sectional view illustrating a state of winding a high-frequency induction coil on an injection nozzle according to further another embodiment of the present invention;

FIG. 10 and FIG. 11 are sectional views illustrating coupling states of a high-frequency induction heating apparatus using the injection nozzle of FIG. 6 and FIG. 7 according to the further another embodiment of the present invention respectively; and

FIG. 12 is a schematically planar view illustrating the formation of the magnetic field through the high-frequency induction heating apparatus using the injection nozzle of FIG. 6 and FIG. 7 according to the further another embodiment of the present invention.

### BEST MODE FOR CARRYING OUT THE INVENTION

A preferred embodiment of the invention will be described in detail below with reference to the accompanying drawings.

Here, according to the non-contact high-frequency induction heating of the present invention, since the energy efficiency is good and the operation thereof can be minutely controlled in comparison with the conventional equipment using a fossil fuel such as a coal or oil and so on, there are many merits in that a product of high quality can be produced and it does not cause an environmental pollution. Accordingly, it is widely applied and used in various industrial fields. By means of the high-frequency induction heating apparatus, a high-frequency current is sent to a coil of a donut shape by using an electromagnetic induction to generate a magnetic field of high-frequency, so that an induced current is applied to a heating object existed in the magnetic field of high-frequency. The induced current is swirled in the object, so that Joule's heat is generated from a hysteresis loss and an eddy current loss, thereby heat is generated in a shortest time. The heating using the heat generated in this manner is called as an induction heating. Here, in case of using a high-frequency current, it is called as a high-frequency induction heating. Also, since high-frequency current is used, a magnetic flux and eddy current are concentrated on the surface layer of the heating object by means of skin effect and proximity effect of the current, so that a heat loss (eddy current loss and hysteresis loss) is generated, thereby heating the surface of the object. By means of the principle, an energy is concentrated on a necessary portion of the object, so that a rapid heating can be efficiently performed, thereby raising a productivity and a working efficiency.

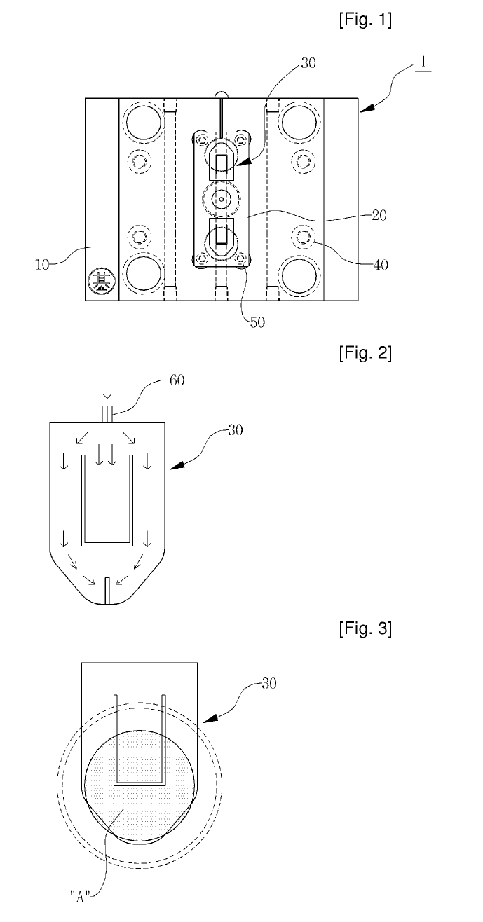

FIG. 1 is a planar view illustrating a plastic injection mold using a non-contact high-frequency induction heating apparatus according to the present invention. As shown in FIG. 1, the plastic injection mold 1 according to the present invention includes a base 10 of an approximately planar plate type, a core 20 located at a center of the base 10, and a cavity 30 for manufacturing a plastic injection molding product located on the core 20. Here, though it is not shown in the figure, the plastic injection mold 1 according to the present invention includes a fixing molding portion and a moving mold portion in order to separate the product from the mold during ejection thereof. Also, the present invention is described on the basis of the plastic injection molding product (for example, a plastic clip), however, it can be used for all kinds of injection molding products.

As shown, two cavities 30 are formed on the core 20, so that a melting resin of high temperature can be injected into the cavities 30 through a runner gate and a runner 60 (note FIG. 2).

Also, the non-contact high-frequency induction heating apparatus 50 according to the present invention formed at four corners of the core 20 serves to partially and ra pidly heat the area of the cavity 30 prior to the injection of the melting resin of high temperature (prior to about 1 to 5 seconds; being changed according to a kind of the product or an amplitude of the supplying electric power), so that it can minimize a temperature variation between the cavity 30 and the melting resin of high temperature, thereby preventing various outward inferiorities of the molding product caused by a large temperature variation between the surface of the cavity 30 and the plastic resin of high temperature. Actually, after the melting resin is injected into the cavity 30 (approximately one second later), the temperature falls to about 150 degrees of comparatively lower temperature (high temperature: about 260 degrees) and then, it becomes lower to a base temperature.

Here, the present invention is described on the basis of the partial area of the cavity 30 as a rapid heating area, however, it may heat the entire area of the mold. Accordingly, the present invention is not limited to the rapid heating area thereof. Also, since it is necessary for the temperature of the mold or cavity to rise to about molding temperature until the injection, a point of the heating time may be appropriately adjusted according to the environment of the non-contact high-frequency induction heating apparatus 50.

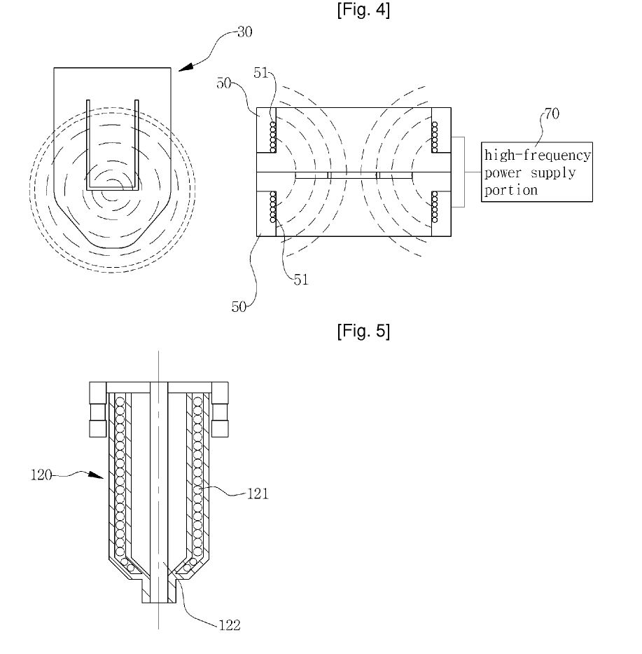

The non-contact high-frequency induction heating apparatus 50 is electrically connected to a high-frequency power supply portion 70 (note FIG. 4) for supplying the high-frequency power (about 1 KHz-300 KHz). Actually, in case of heating the mold 1 through the non-contact high-frequency induction heating apparatus 50 according to the present invention, it can be sufficiently heated through the heating apparatus 50 having a capacity of 300 KHz-10 kw of electricity. Also, it can heat the mold or the cavity to 250 degrees in about 1 through 2 seconds.

Four cooling apparatuses 40 of mold located at the outside of the base 10 includes a plurality of cooling holes (not shown) located at the periphery of the cavity of the fixing molding portion in a predetermined interval and a cooling water source (not shown) for supplying the cooling water for circulating along the cooling holes. Also, the supply of the cooling water can be controlled by means of a separate controller.

Here, the cooling water is supplied for a predetermined hardening time from a lapse of a certain period of time after the completion of the resin injection. Also, the supply of the cooling water is stopped at the separation period of the moving mold portion for ejecting the molding product.

FIG. 2 is a schematically planar view illustrating a flow of a melting resin of high temperature in a cavity, FIG. 3 is a schematically planar view illustrating a partial area of a cavity of heating rapidly by means of a non-contact high-frequency induction heating apparatus for plastic mold according to the present invention, and FIG. 4 is a schematically planar view illustrating the formation of the magnetic field through a non-contact high-frequency induction heating apparatus for plastic mold according to the present invention. For the convenience of description, the following description will be made while simultaneously referring to both FIG. 2 through FIG. 4.

Firstly, as shown in FIG. 2, when the melting resin of high temperature is injected into the cavity 30 via the runner 60, it divides into three in the direction of an arrow. At this time, in prior art, at the lower part of the cavity 30 of joining three sections together, the inferiority of the molding product such as combination traces, that is, a weld line, a short shot, a spot and so on is generated owing to the heat loss through the movement thereof. However, as shown in FIG. 3, since the rapidly heating area “A” (high temperature: up to about 260 degrees) is formed at the cavity 30 owing to the heat of the magnetic field through the non-contact high-frequency induction heating apparatus 50 for plastic mold according to the present invention, the inferiority of the molding product such as the weld line, the short shot, the spot and so forth is not generated at all.

As shown in FIG. 4, a plurality of wound high-frequency induction coils 51 is electrically connected to the high-frequency power supply portion 70, so that the magnet field is generated, thereby the partial area of the cavity 30 is rapidly heated.

FIG. 5 is a schematic sectional view illustrating an injection nozzle of a non-contact high-frequency induction heating apparatus according to one embodiment of the present invention.

As shown in FIG. 5, the injection nozzle 120 attached to a melting resin injection apparatus serves to inject the meting resin into the above plastic injection mold 1 (note FIG. 1) according to the present invention. The injection nozzle 120 includes a high-frequency induction coil 121 wound along the periphery thereof.

That is, the high-frequency induction coil 121 is wound along the outer circumference of a runner 122 of the injection nozzle 120 in order to partially and rapidly heat the area of the runner 122 of the injection nozzle 120 by means of the high-frequency induction magnetic field. Here, after the injection of the melting resin for molding the plastic product, the area of the runner 122 is directly cooled to be hardened so as to separate the inlet thereof from the plastic injection mold 1.

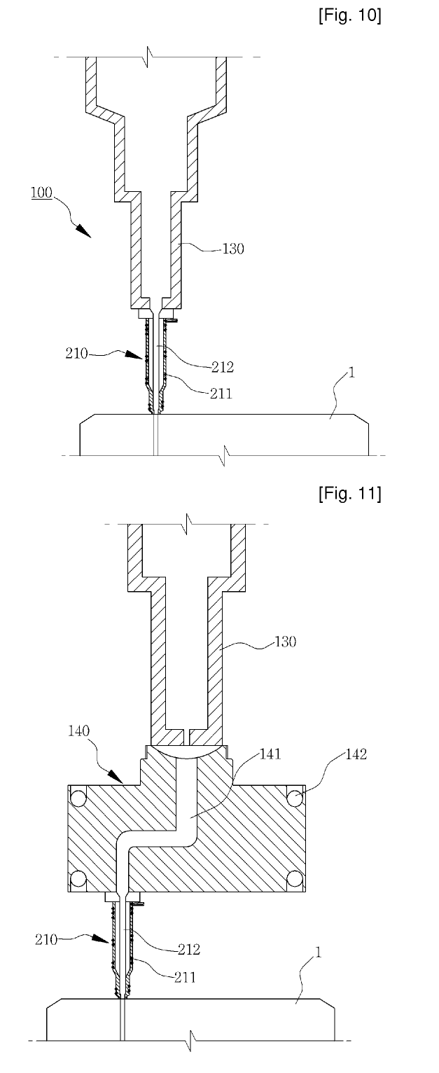

Also, the high-frequency induction coil 121 is electrically connected to the high-frequency power supply portion 70 (note FIG. 4; supplying the high-frequency power to the mold and injection nozzle heating apparatuses together), so that the area of the runner 122 of the injection nozzle 120 for connecting the melting resin injection apparatus 130 (note FIG. 10) to the plastic injection mold 1 (note FIG. 10) can be rapidly heated by means of the high-frequency induction magnetic field of the high-frequency induction coil 121.

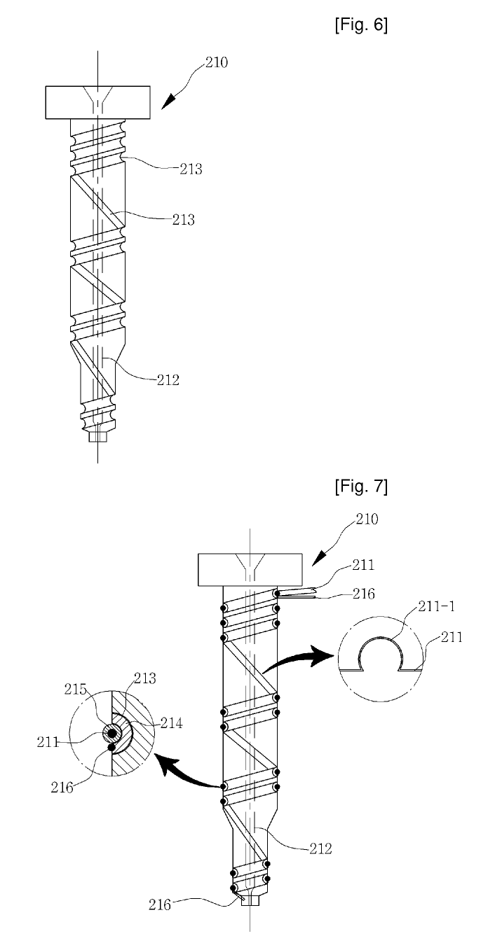

FIG. 6 is a schematic sectional view illustrating an injection nozzle of a non-contact high-frequency induction heating apparatus according to another embodiment of the present invention and FIG. 7 is a sectional view illustrating a state of winding a high-frequency induction coil on the injection nozzle of FIG. 6. For the convenience of description, the following description will be made while simultaneously referring to both FIG. 6 and FIG. 7.

As shown, the injection nozzle 210 attached to a melting resin injection apparatus serves to inject the meting resin into the above plastic injection mold 1 (note FIG. 10) according to the present invention. The injection nozzle 210 includes a spiral groove 213 formed at the periphery thereof and a runner 212 for injecting the melting resin penetrated through of the center thereof lengthwise.

As shown in FIG. 7, a high-frequency induction coil 211 is wound along the spiral groove 213 of the injection nozzle 210. More concretely, the spiral groove 213 and the high-frequency induction coil 211 further includes an insulating layer 214 made of a ceramic etc. coated on the spiral groove 213 and a covering material 215 made of an insulating resin material such as a Teflon covering the high-frequency induction coil 211. Accordingly, the high-frequency induction coil 211 having the covering material 215 is wound along the insulating layer 214 of the spiral groove 213. Also, a temperature detection sensor line 216 for detecting the temperature of the runner 212 can be wound along the spiral groove 213 together with the high-frequency induction coil 211.

In FIG. 6 and FIG. 7, the spiral groove 213 is integrally formed at the injection nozzle 210. However, a spiral protrusion instead of the spiral groove 213 is integrally formed at the injection nozzle 210, so that the high-frequency induction coil 211 can be wound along the spiral protrusion.

Here, the spiral groove 213 can be uniformly formed at the periphery of the injection nozzle 210 on the whole. However, it is preferred that the spiral groove 213 is concentrically formed at a partial area thereof in consideration of processing cost of the groove. That is, it is preferred that the spiral groove 213 is concentrically formed on at least any one among a front portion, a central portion and a rear portion. In other words, the spiral groove 213 can be concentrically formed on the front portion or the central portion of the injection nozzle 210, or the spiral groove 213 can be concentrically formed on the front portion and rear portion thereof.

Especially, since the entire shape of the injection nozzle 210 becomes gradually narrow toward the rear portion thereof, the heating temperature is comparatively high at the nozzle tip, which is located at the rear portion thereof, owing to a pressure difference thereof. Also, the front portion of the injection nozzle 210 of injecting directly the melting resin through the melting resin injection apparatus 130 (note FIG. 10) or a manifold 140 (note FIG. 10) is comparatively high in terms of heating temperature. However, the heating temperature of the central portion thereof is comparatively low in comparison with the front portion or the rear portion thereof. Accordingly, in a case that the spiral groove 213 is concentrically formed on the central portion of the injection nozzle 210, there is a merit in that the entire heating temperature of the injection nozzle 210 can be maintained uniformly and high.

As shown in FIG. 7, the high-frequency induction coil 211 wound along the spiral groove 213 of the injection nozzle 210 includes a plurality of loops 211-1. In this manner, since the plurality of loops 211-1 is formed at the high-frequency induction coil 211, as though the high-frequency induction coil 211 becomes hot to be lengthened owing to a rise in temperature according to the rapid heating of the runner 212 of the injection nozzle 210, the plurality of loops 211-1 can absorb the expanded high-frequency induction coil 211.

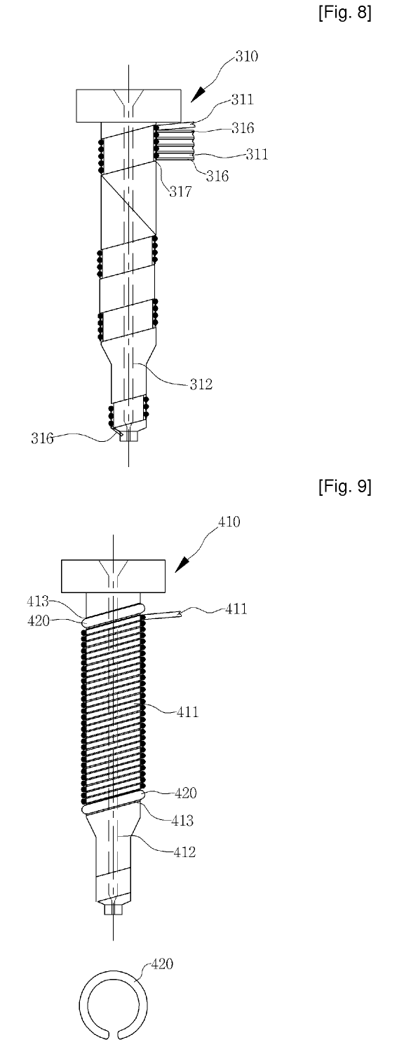

FIG. 8 is a sectional view illustrating a state of winding a high-frequency induction coil on an injection nozzle according to further another embodiment of the present invention. There is a difference in that a spiral groove 317 of the injection nozzle 310 is larger than that of FIG. 7.

That is, in order to decrease the processing cost of the spiral groove further, one spiral groove 317 is widely formed on at least any one among a front portion, a central portion and a rear portion of the injection nozzle 310 and a high-frequency induction coil 311 is concentrically wound along the broad spiral groove 317 of the injection nozzle 310.

FIG. 9 is a sectional view illustrating a state of winding a high-frequency induction coil on an injection nozzle according to further another embodiment of the present invention. There is a difference in that a spiral groove 413 is formed at upper and lower portions of the injection nozzle 410 one by one in comparison with that of FIG. 7.

That is, in order to decrease the processing cost of the spiral groove further, one spiral groove 413 is formed at only front and rear portions of the injection nozzle 410 respectively. Also, two metallic C-rings 420 are inserted into and fixed to two spiral grooves 413 respectively and both ends of a high-frequency induction coil 411 are inserted into and fixed to two metallic C-rings 420 and then, the high-frequency induction coil 411 is wound along the injection nozzle 410.

FIG. 10 is a sectional view illustrating a coupling state of a high-frequency induction heating apparatus using the injection nozzle of FIG. 6 and FIG. 7. Here, the high-frequency induction heating apparatus 100 for injection nozzle is used in the injection nozzle 210 of FIG. 6 and FIG. 7 in FIG. 10. However, the high-frequency induction heating apparatus 100 for injection nozzle may be equally applied to the injection nozzles 110 and 310 of FIG. 5 and FIG. 8.

As shown in FIG. 10, the high-frequency induction heating apparatus 100 for injection nozzle according to the present invention includes the injection nozzle 210 attached to the melting resin injection apparatus and having the spiral groove 213 formed at the periphery thereof and a runner 212 for injecting the melting resin into the plastic injection mold 1 and the high-frequency induction coil 211 wound along the spiral groove 213 of the injection nozzle 210 as a non-contact high-frequency induction heating apparatus.

Also, the high-frequency induction coil 211 is electrically connected to the high-frequency power supply portion 70 (note FIG. 4), so that the area of the runner 212 of the injection nozzle 210 for connecting the melting resin injection apparatus 130 to the plastic injection mold 1 can be rapidly heated by means of the high-frequency induction magnetic field of the high-frequency induction coil 211.

Also, the high-frequency induction coil 211 as the non-contact high-frequency induction heating apparatus is wound along the spiral groove 213 formed at the outer circumference of the injection nozzle 210 in order to partially and rapidly heat the entire area of the runner 212 of the injection nozzle 210 by means of the high-frequency induction magnetic field. Here, after the injection of the melting resin for molding the plastic product, the area of the runner 122 is directly cooled to be hardened so as to separate the inlet thereof from the plastic injection mold 1.

Here, the non-contact high-frequency induction heating apparatus 100 for injection nozzle according to the present invention serves to partially and rapidly heat the area of the runner 212 of the injection nozzle 210 prior to the injection of the melting resin of high temperature of the melting resin injection apparatus 130 into the plastic injection mold 1 through the runner 212 (prior to about 1 to 5 seconds; being changed according to a kind of the product or an amplitude of the supplying electric power), so that it can minimize a temperature variation between the runner 212 and the melting resin of high temperature, thereby the melting resin can be flowed into it well. Accordingly, it can prevent the hardening of the melting resin in the runner 212 of the injection nozzle 210.

The high-frequency induction coil 211 as the non-contact high-frequency induction heating apparatus is electrically connected to a high-frequency power supply portion 70 (note FIG. 4) for supplying the high-frequency power (about 1 KHz-300 KHz). Actually, in case of heating the runner of the injection nozzle through the high-frequency induction coil 211 as the non-contact high-frequency induction heating apparatus according to the present invention, it can be sufficiently heated through the heating apparatus having a capacity of several hundred KHz ? several tens kw of electricity. Also, it can heat the mold or the cavity to 250 degrees in the shortest time. In the non-contact high-frequency induction heating apparatus 100 for injection nozzle according to the present invention, since the melting resin is directly injected into the plastic injection mold 1 through the injection nozzle 210 without forming a separate manifold, the melting resin injection apparatus become very simple, thereby curtailing expenses.

FIG. 11 is a sectional view illustrating a coupling state of a high-frequency induction heating apparatus using the injection nozzle of FIG. 6 and FIG. 7 according to the further another embodiment of the present invention.

Here, the high-frequency induction heating apparatus for injection nozzle of FIG. 11 is essentially identical with that of FIG. 10, except that the melting resin injection apparatus 130 is connected to the injection nozzle 210 via the manifold 140. Accordingly, the same reference numerals will be used to designate the same or similar components and it will be described around those differences existing herein below.

As shown in FIG. 11, the high-frequency induction heating apparatus for injection nozzle further includes the manifold 140 as a resin connector between the melting resin injection apparatus 130 and the injection nozzle 210. Here, it is preferred that the manifold is connected to at least two injection nozzles.

In the manifold 140, the melting resin of high temperature flowed from the melting resin injection apparatus 130 can be continuously maintained in a runner 141 thereof in a melted state prior to the molding of the product in the plastic injection mold 1 by transferring it to the injection nozzle 210 through the runner 141 of the manifold 140 during producing the plastic product. That is, a heating apparatus 142 using a direct heating manner formed at the outside of the manifold servers to only keep the melting resin located at the runner 141 warm during the injection of the melting resin of high temperature for continuously producing the plastic product.

The heating apparatus 142 of the direct heating manner may be a column type heater or a cartridge heater. However, the present invention is not limited to the heating manner thereof.

In the meantime, in the injection nozzle 210 for injecting the melting resin into the runner gate (not shown) of the plastic injection mold 1, since the heating thereof is conducted in a shortest time and the runner of the injection 210 is directly cooled to be hardened so as to separate it from the plastic injection mold 1, the high-frequency induction coil 211 as the non-contact high-frequency induction heating apparatus is wound along the spiral groove 213 of the injection nozzle 210, unlike the heating apparatus 142 of the manifold 14 using the direct heating manner.

By means of the form of the high-frequency induction coil 211, the runner 212 of the injection nozzle 120 is partially and rapidly heated. Also, after the injection of the melting resin for molding the plastic product, the area of the runner 212 can be directly cooled to be hardened so as to separate the inlet thereof from the plastic injection mold 1.

Also, the injection nozzle 210 and the manifold 140 can be attached and deattached to each other through a screw coupling manner and so on, so that the injection nozzle 210 can be applied to various manifolds 140.

Accordingly, in the non-contact high-frequency induction heating apparatus for injection nozzle according to the further another embodiment of the present invention, the non-contact high-frequency induction heating apparatus is applied to the injection nozzle while the conventional direct heating manner is used in the manifold, so that a hot runner structure of new concept is presented, thereby satisfying economical efficiency and quality at same time.

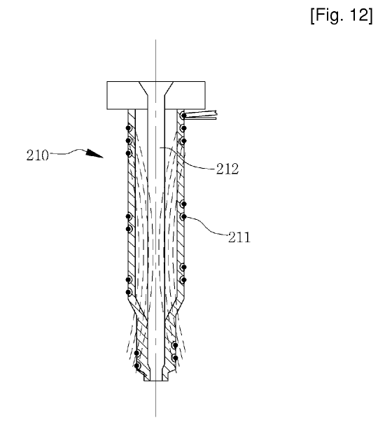

FIG. 12 is a schematically planar view illustrating the formation of the magnetic field through the high-frequency induction heating apparatus using the injection nozzle of FIG. 6 and FIG. 7 according to the further another embodiment of the present invention. Here, the high-frequency induction heating apparatus 100 for injection nozzle is used in the injection nozzle 210 of FIG. 6 and FIG. 7 in FIG. 10. However, the high-frequency induction heating apparatus 100 for injection nozzle may be equally applied to the injection nozzles 110 and 310 of FIG. 5 and FIG. 8.

As shown in FIG. 12, the high-frequency current from the high-frequency power supply portion (not shown) is supplied to the high-frequency induction coil 211 wound along the spiral groove or the spiral protrusion integrally formed at the peripheral of the injection nozzle 210 as the non-contact high-frequency induction heating apparatus in order to form the magnetic field. Then, the runner 212 of the injection nozzle 210 is partially and rapidly heated by means of the induced current of the high-frequency induction magnetic field. Also, after the injection of the melting resin for molding the plastic product, the runner 212 of the injection nozzle 210 is directly cooled so as to separate the inlet thereof from the plastic injection mold, so that the fluctuation in temperature can be repeated in short time during the continuous molding of the product. Also, the interval between the injection nozzle and the induction coil is removed in comparison with the conventional art, thereby minimizing a loss of an induced power.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The present invention relates to a non-contact high-frequency induction heating apparatus for plastic mold and injection nozzle thereof in that only a partial area of a cavity and a runner area of an injection nozzle are rapidly heated by means of a non-contact high-frequency induction heating manner during the injection of a melting resin of high temperature, so that it can minimize a temperature variation between the cavity and runner and the melting resin of high temperature in order to smoothly supply the melting resin to the cavity and injection nozzle, whereby preventing various outward inferiorities of the molding product and improving the efficiency of the melting resin injection apparatus.

1. A non-contact high-frequency induction heating apparatus for plastic mold having a core and a cavity comprising: at least one high-frequency induction coil formed at an outside of the cavity; and a high-frequency power supply portion for supplying a high-frequency power to the high-frequency induction coil so as to rapidly heat only the cavity by means of a magnetic field of the high-frequency induction coil.

2. A non-contact high-frequency induction heating apparatus for plastic mold claimed in claim 1, wherein the high-frequency induction coil is at least one wound coil.

3. A non-contact high-frequency induction heating apparatus for plastic mold claimed in claim 1, wherein the cavity is rapidly heated prior to an injection of a melting resin of high temperature into the cavity.

4. A non-contact high-frequency induction heating apparatus for plastic mold claimed in claim 1, wherein a plurality of cooling apparatuses using a cooling water supplying manner is formed at an outside of the core.

5. A non-contact high-frequency induction heating apparatus for plastic mold claimed in claim 1, further comprising a controller for controlling the high-frequency power supplied to the high-frequency induction coil through the high-frequency power supply portion and a cooling water supplied to a cooling apparatus.

6. A non-contact high-frequency induction heating apparatus for injection nozzle of a plastic mold comprising: an injection nozzle for injecting a melting resin from a melting resin injection apparatus into the plastic mold; a high-frequency induction coil wound along a periphery of the injection nozzle; and a high-frequency power supply portion for supplying a high-frequency power to the high-frequency induction coil so as to rapidly heat a runner of the injection nozzle by means of a magnetic field of the high-frequency induction coil.

7. A non-contact high-frequency induction heating apparatus for injection nozzle of a plastic mold claimed in claim 6, wherein the injection nozzle comprises a spiral groove formed at a periphery thereof and the high-frequency induction coil is wound along the spiral groove.

8. A non-contact high-frequency induction heating apparatus for injection nozzle of a plastic mold claimed in claim 6, wherein the injection nozzle comprises a spiral protrusion formed at a periphery thereof and the high-frequency induction coil is wound along the spiral protrusion.

9. A non-contact high-frequency induction heating apparatus for injection nozzle of a plastic mold claimed in claim 7, wherein the spiral groove or spiral protrusion are concentrically formed on at least any one among a front portion, a central portion and a rear portion of the injection nozzle.

10. A non-contact high-frequency induction heating apparatus for injection nozzle of a plastic mold claimed in claim 7, wherein the spiral groove or spiral protrusion are widely formed on at least any one among a front portion, a central portion and a rear portion of the injection nozzle and the high-frequency induction coil is concentrically wound along the widen spiral groove or spiral protrusion.

11. A non-contact high-frequency induction heating apparatus for injection nozzle of a plastic mold claimed in claim 7, wherein two spiral grooves are formed at upper and lower portions of the injection nozzle respectively, two metallic C-rings are inserted into and fixed to the spiral grooves respectively, both ends of the high-frequency induction coil are inserted into and fixed to the metallic C-rings and then, the high-frequency induction coil is wound along a space between the spiral grooves of the injection nozzle.

12. A non-contact high-frequency induction heating apparatus for injection nozzle of a plastic mold claimed in claim 7, wherein a temperature detection sensor line for detecting a temperature of the runner is wound along the spiral groove or spiral protrusion together with the high-frequency induction coil.

13. A non-contact high-frequency induction heating apparatus for injection nozzle of a plastic mold claimed in claim 7, wherein the high-frequency induction coil wound along the spiral groove or spiral protrusion of the injection nozzle comprises a plurality of loops.

14. A non-contact high-frequency induction heating apparatus for injection nozzle of a plastic mold claimed in claim 7, wherein the melting resin injection apparatus is connected to the injection nozzle via a manifold.

15. A non-contact high-frequency induction heating apparatus for injection nozzle of a plastic mold claimed in claim 14, wherein a heating apparatus for heating a runner of the manifold is formed at an outside of the manifold.

16. A non-contact high-frequency induction heating apparatus for injection nozzle of a plastic mold claimed in claim 6, wherein the runner of the injection nozzle is rapidly heated prior to an injection of a melting resin of high temperature into the runner of injection nozzle.
